(19) United States
(12) Patent Application Publication
(10) Pub. No.: US 2006/0196319 A1
(43) Pub. Date: Sep. 7, 2006

(54) Adjustable wrench

(76) Inventors: Ching-Fang Hung, Dali City (TW); Hao-Cheng Cheng, Taiping City (TW)

Correspondence Address: DELLETT & WALTERS, P. O. BOX 82788, PORTLAND, OR, 97282-0788, US

(21) Appl. No.: 11/213,225

(22) Filed: Aug. 26, 2005

(30) Foreign Application Priority Data
Mar. 3, 2005 (TW) 094203272

(51) Int. Cl. B25B 13/22

(52) U.S. Cl. 81/133; 81/129.5

(57) ABSTRACT

An adjustable wrench has a body, a movable jaw, a pinion, a sliding rack and a positioning device. The pinion is rotatably mounted between and engages the movable jaw and the sliding rack. The pinion longitudinally extends or retracts the movable jaw quickly when the sliding rack is moved. Moreover, the positioning device locks the sliding rack in position to keep the movable jaw stable in use.

### BACKGROUND OF THE INVENTION

1. Field of the Invention

The present invention relates to an adjustable wrench, and more particularly to a wrench having an adjustable jaw that can be adjusted rapidly and stably.

2. Description of Related Art

A conventional adjustable wrench in accordance with the prior art comprises a handle, a stationary jaw, an adjustable jaw and a nut. The handle has a distal end and a proximal end. The stationary jaw is formed at the distal end of the handle. The adjustable jaw is L-shaped, is attached movably to the distal end of the handle and has a jaw and a threaded neck. The jaw is aligned with the stationary jaw and separated from the stationary jaw by a variable distance. The threaded neck is mounted longitudinally in the distal end of the shaft. The nut is mounted rotatably inside the handle and screws around the threaded neck of the adjustable jaw. Therefore, the adjustable jaw moves closer to or away from the stationary jaw when the nut is rotated and is held at desired positions to accommodate various sizes of working pieces such as nuts, bolts and pipes.

However, the conventional adjustable wrench has the following drawbacks:

1. When the nut rotates once as the adjustable jaw is being adjusted, the adjustable jaw moves only a very distance in the longitudinal direction. Therefore, adjustment of the adjustable jaw is time-consuming and inconvenient.

2. Thread gaps forms between the threaded neck of the adjustable jaw and the nut because the conventional adjustable wrench does not have a positioning device. Therefore, the adjustable jaw easily loosens and cannot clamp the working piece firmly.

To overcome the shortcomings, the present invention provides an adjustable wrench to mitigate or obviate the aforementioned problems.

### SUMMARY OF THE INVENTION

A main objective of the invention is to provide an adjustable wrench that can be adjusted rapidly.

Another main objective of the invention is to provide an adjustable wrench that is reliable and faithful in operation.

An adjustable wrench in accordance with the present invention has a body, a movable jaw, a pinion, a sliding rack and a positioning device.

The pinion is rotatably mounted between and engages the movable jaw and the sliding rack. The pinion longitudinally extends or retracts the movable jaw quickly when the sliding rack is moved. Moreover, the positioning device locks the sliding rack in position to keep the movable jaw stable in use.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an adjustable wrench in accordance with the present invention;

FIG. 2 is a side view in partial section of the adjustable wrench in FIG. 1;

FIG. 3 is a cross-sectional front view of the adjustable wrench along line 3-3 in FIG. 2;

FIG. 4 is a bottom view in partial section of the adjustable wrench in FIG. 2;

FIG. 5 is an operational side view in partial section of the adjustable wrench in FIG. 2; and

FIG. 6 is a bottom view in partial section of a positioning device in the adjustable wrench in FIG. 5.

### DETAILED DESCRIPTION OF PREFERRED EMBODIMENT

An adjustable wrench in accordance with the present invention comprises a body, a movable jaw, a pinion, a sliding rack and a positioning device. The pinion is rotatably mounted between and engages the movable jaw and the sliding rack. The pinion longitudinally extends or retracts the movable jaw quickly when the sliding rack is moved. Moreover, the positioning device locks the sliding rack in position to keep the movable jaw stable in use.

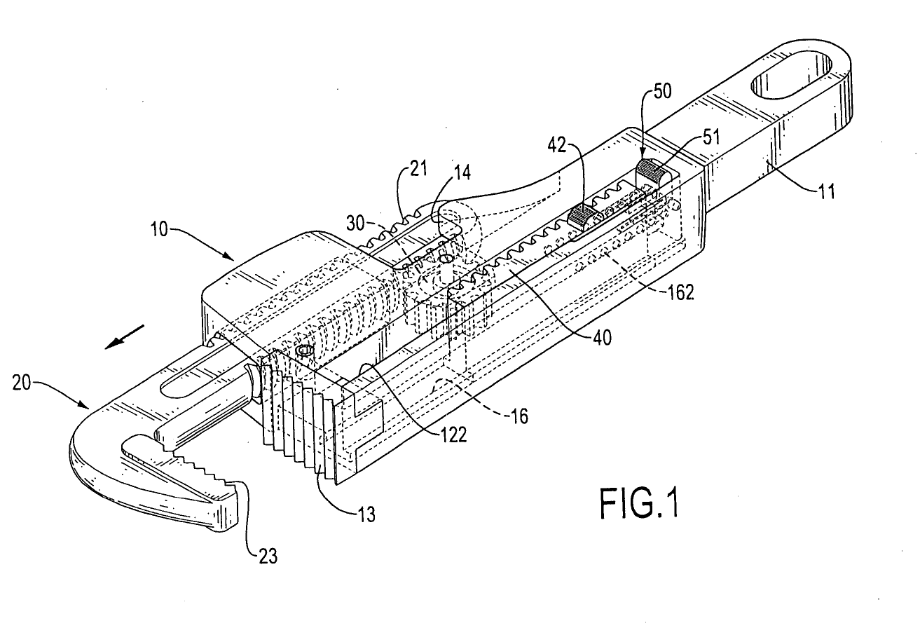

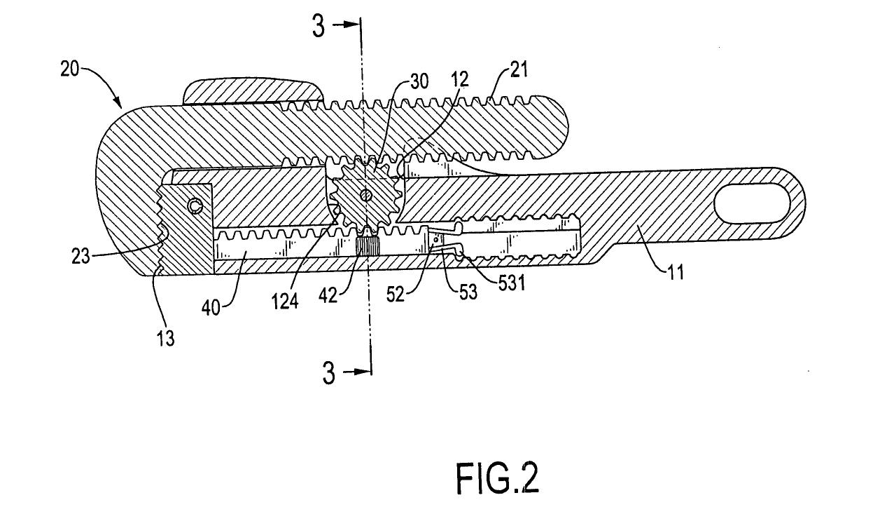

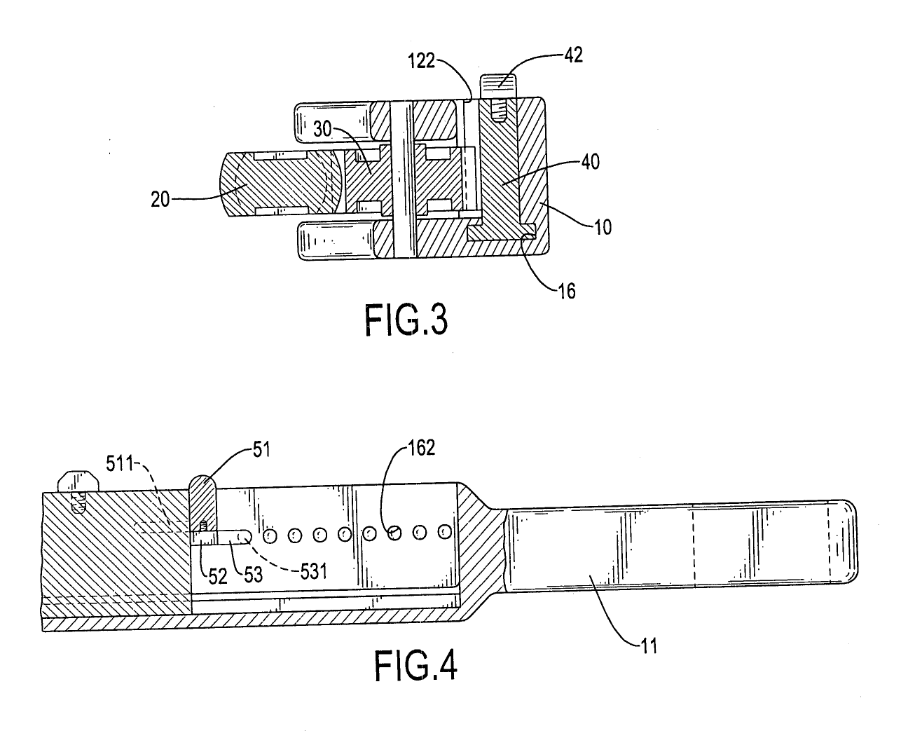

With reference to FIGS. 1 to 3, a preferred embodiment of the adjustable wrench comprises a body (10), a movable jaw (20), a pinion (30), a sliding rack (40) and a positioning device (50).

The body (10) is elongated and has an interior cavity, a front end, a rear end, a top edge, two sides, a handle (11), a stationary jaw (13) and a recess (14). The interior cavity is defined inside the body (10) and has a top opening (12), a pinion recess (124), a channel (16) and a longitudinal opening (122). The top opening (12) is formed between the front and rear ends at the top edge of the body (10). The pinion recess (124) is formed in the body (10) and communicates with the top opening (12). The channel (16) is formed longitudinally in the body (10), extends to one side of the body (10) to define the longitudinal opening (122), communicates with the pinion recess (124), preferably is inverted T-shaped and has a rear end, a top surface, a bottom surface and multiple detents (162). The detents (162) are formed in line longitudinally in the top and bottom surfaces near the rear end. The handle (11) is attached to and protrudes longitudinally from the rear end of the body (10). The stationary jaw (13) is mounted in the front end and has a transverse jaw surface and multiple optional teeth. The teeth are formed on the transverse jaw surface. The recess (14) is defined in the top edge of the body (10) between the front and rear ends and communicates with the pinion recess (124) in the interior cavity.

The movable jaw (20) is L-shaped, is movably mounted in the front end of the body (10) and has a transverse head and a neck. The neck is mounted inside the body (10) near the recess (14) and has a top edge, a bottom edge and multiple teeth (21). The teeth (21) are formed in the top and bottom edges and align with the recess (14) so the teeth (21) are revealed in the recess (14) via the top opening (12) when the neck is mounted into the recess (14). The transverse head is outside the front end of the body (10), protrudes perpendicularly from the neck, is aligned with the stationary jaw (13) and has a jaw (23). The jaw (23) is aligned with the stationary jaw (13), has multiple optional teeth and, in conjunction with the stationary jaw (13), clamps an object such as a nut, a bolt or a pipe.

The pinion (30) is rotatably mounted inside the pinion recess (124) in the body (10), protrudes into the recess (14) and the channel (16) and engages the teeth (21) on the neck of the movable jaw (20).

The sliding rack (40) is movably mounted inside the channel (16) parallel to the neck of the adjustable jaw (20) and has a top face, a bottom face, an outer side, an inner side, a rear end, multiple teeth (not numbered) a push tab (42) and two optional flanges. The teeth are formed on the top face, engage the pinion (30) and rotate the pinion (30) when the sliding rack (40) slides in the channel (16), which extends or retracts the movable jaw (20). The push tab (42) is formed on the outer side near the rear end to allow a person to slide the sliding rack (40) easily. The flanges extend respectively from the top face and the bottom face at the inner side and correspond to the preferable inverted T-shaped channel (16) to hold the sliding rack (40) in the channel (16).

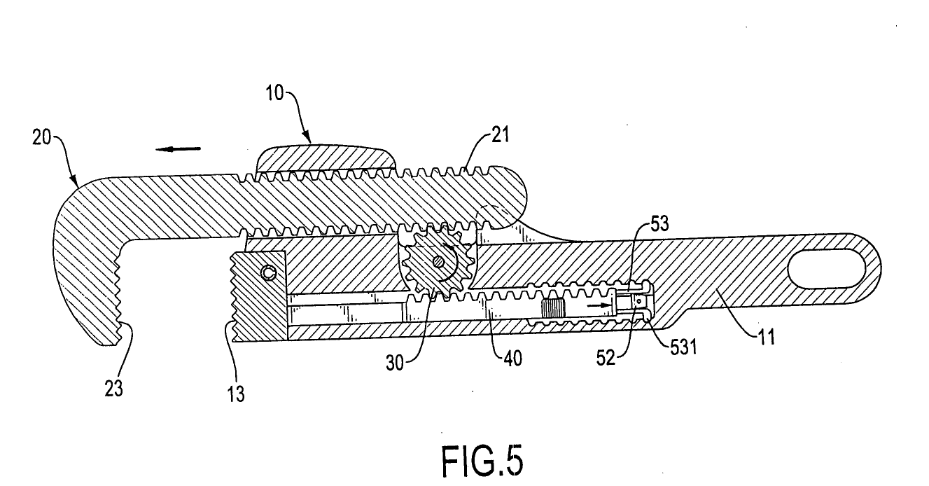

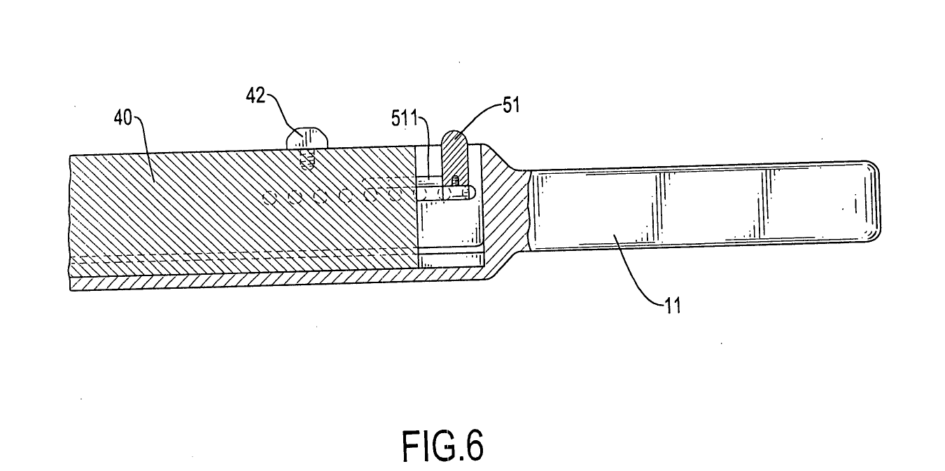

With further reference to FIGS. 4 and 5, the positioning device (50) is attached to the rear end of the sliding rack (40) and comprises a base (51), a screw, a limit (52) and two resilient legs (53). The base (51) has a pin (511) mounted slidably in the rear end of the sliding rack (40). The limit (52) is attached to the base (51) with the screw and has two sides and a tapered distal end. The two resilient legs (53) extend from the rear end of the sliding rack (40) and respectively abut the two sides of the limit (52). Each resilient leg (53) has a distal end and a stub (531). The stubs (531) are formed respectively at the distal ends of the legs (53), protrude outward respectively to abut the top and bottom surfaces of the channel (16) and selectively engage the detents (162). With further reference to FIG. 6, the stubs (531) on the resilient legs (53) move into and out of the detents (162) when the base (51) is pressed toward the sliding rack (40). When the base (51) is pulled back between the legs (53), the limit (52) presses the legs (53) outward and holds the stubs (531) in the corresponding detents (162), and the sliding rack (40) is locked in position to keep the movable jaw (20) stable.

The adjustable wrench has the following advantages:

1. The sliding rack (40) and the pinion (30) rapidly move the movable jaw (20) with the application of a straight axial force. Therefore, adjustment of the movable jaw (20) is easy and fast.

2. The adjustable wrench of the present invention is stable and reliable in use because the positioning device (50) on the adjustable wrench securely holds the movable jaw (20) in position.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An adjustable wrench comprising:
a body being elongated and having
a front end;
a rear end;
a top edge;
two sides
a handle attached to and protruding longitudinally from the rear end of the body; and
an interior cavity defined inside the body and having
a top opening formed between the front and rear ends;
a pinion recess formed in the body and communicating with the top opening; and
a channel formed longitudinally in the body, extending to one side of the body to defined a longitudinal opening, communicating with the pinion recess and having
a rear end;
a top surface; and
a bottom surface;
a stationary jaw mounted in the front end of the body and having a transverse jaw surface; and
a recess defined in the top edge of the body between the front and rear ends and communicating with the interior cavity.
a movable jaw being L-shaped, movably mounted in the front end of the body and having
a neck mounted inside the body and having
a top edge;
a bottom edge; and
multiple teeth formed in the top and bottom edges of the neck and aligning with the recess; and
a transverse head being outside the body, protruding perpendicularly from the neck, aligning with the stationary jaw and having a jaw to align with the stationary jaw;
a pinion rotatably mounted inside the body and engaging the multiple teeth on the movable jaw;
a sliding rack movably mounted inside the channel parallel the neck of the adjustable jaw, having
a top face;
a bottom face;
an outer side;
an inner side;
a rear end;
multiple teeth formed the top face, engaging the pinion and rotating the pinion when the sliding rack slides in the channel; and
a push tab formed on the outer side near the rear end; and
a positioning device attached to the rear end of the sliding rack.

2. The adjustable wrench as claimed in claim 1, wherein:
the channel further has multiple detents formed in line longitudinally in the top and bottom surfaces near the rear end inside the channel; and
the positioning device has
a base having a pin mounted slidably in the rear end of the sliding rack;
a screw;
a limit attached to the base with the screw and having two sides and a tapered distal end; and
two resilient legs extending from the rear end of the sliding rack and respectively abutting the two sides of the limit, and each resilient leg has
a distal end; and
a stub formed at the distal end and protruding outward to abut the top and bottom surfaces of the channel and engage the detents.

3. The adjustable wrench as claimed in claim 1, wherein:
the channel is inverted T-shaped; and
the sliding rack has two flanges extending respectively from the top face and the bottom face of the sliding rack and corresponding to the inverted T-shaped channel.

4. The adjustable wrench as claimed in claim 2, wherein:
the channel is inverted T-shaped; and
the sliding rack has two flanges extending respectively from the top face and the bottom face of the sliding rack and corresponding to the inverted T-shaped channel.

5. The adjustable wrench as claimed in claim 1, wherein:
the stationary jaw has multiple teeth formed on the transverse jaw surface; and
the jaw on the transverse head of the movable jaw has multiple teeth to correspond to the multiple teeth on the stationary jaw.
